(19) United States
(12) Patent Application Publication
(10) Pub. No.: US 2026/0295313 A1
(43) Pub. Date: Oct. 1, 2026

(54) FIRE WALL PANEL WITH REINFORCED COLUMNS

(71) Applicant: PNK Holdings LLC, New York, NY (US)

(72) Inventor: Ilia SABIROV, Moscow (RU)

(21) Appl. No.: 19/097,124

(22) Filed: Apr. 1, 2025

(51) Int. Cl. A62C 2/06

(52) U.S. Cl. CPC A62C 2/06

(57) ABSTRACT

The present invention is directed to a fire wall panel system. The system is provided with a plurality of panels, each panel of the plurality of panels is fixedly connected to another panel of the plurality of panels, and each panel includes a first portion and a second portion. Additionally, a joint system configured to fixedly connect the panels of the plurality of panels is provided. The at least two columns configured to fixedly connect on each side of the plurality of panels. The joint system can be provided with a fire retardant, and the joint system is devoid of additional joining parts to fixedly connect the plurality of panels, and the plurality of panels with the at least two columns.

### TECHNICAL FIELD

The present disclosure generally relates to fire protection systems in industrial buildings. More specifically, the present invention relates to a fire wall panel system with reinforced concrete columns, which is able provide fire resistance for a period of time, for example, for at least 180 minutes.

### BACKGROUND

As building fire safety regulations require fire-resistant partitions to limit fire spread within structures.

Fire-rated construction components and assemblies are commonly used in the construction industry. The fire-rated components often incorporate fire-retardant materials which substantially block the path of the fire, heat or smoke for at least some period of time. Intumescent materials work well for this purpose, because they swell and char when exposed to flames helping to create a barrier to the fire, heat, and/or smoke.

Existing solutions also often involve complex construction techniques, additional structural support, or materials that require extensive finishing work. Fire-rated wall construction components and assemblies are also commonly used in the construction industry. These components and assemblies are aimed at preventing fire, heat, and smoke from leaving one portion of a building or room and entering another, usually through vents, joint in walls, or other openings. The components often incorporate fire-retardant materials which substantially block the path of the fire, heat, or smoke for at least some period of time. Intumescent materials work well for this purpose, since they swell and char when exposed to flames, helping to create a barrier to the fire, heat, and/or smoke.

Some fire-retardant wall systems include a header track that incorporates a fire-retardant material directly on the header track. The track is configured to at least substantially prevent the passage of air through a head-of-wall gap in conditions prior to any expansion of a heat-activated expandable fire-retardant material or prior to complete expansion or expansion of the heat-activated expandable fire-retardant material sufficient enough to close the head-of-wall gap.

Yet, there is a need for a prefabricated fire wall system that ensures fast installation, structural stability, and high fire resistance that can be used in multipurpose industrial buildings.

The panels of such a system play an integral role in meeting sometimes very demanding specifications for the industrial buildings. A solution for meeting the demand for maintaining a favorable indoor environment within the building, speed of the construction and safety requirements can be met by a fire wall panel system with reinforced concrete columns, which is able provide fire resistance for a period of time, and that can be used in a construction system for erecting multipurpose industrial buildings with the controlled indoor environment.

### SUMMARY

In one aspect, the present invention provides for a fire wall panel system. The system is provided with a plurality of panels, each panel of the plurality of panels is fixedly connected to another panel of the plurality of panels, and each panel includes a first portion and a second portion. Additionally, a joint system configured to fixedly connect the panels of the plurality of panels is provided. The at least two columns configured to fixedly connect on each side of the plurality of panels. The joint system can be provided with a fire retardant and the joint system is devoid of additional joining parts to fixedly connect the plurality of panels, and the plurality of panels with the at least two columns.

In another aspect, the present invention provides for a method for installing a fire wall panel system. The method includes providing at least two columns, each column having a groove. The next steps are placing a plurality of panels from top to bottom between the at least two columns and providing a joint system configured to fixedly connect the panels of the plurality of panels. The joint system can have a first member and a second member. Further, the step is covering the first member and the second member with a fire retardant, and, finally, engaging the joint system configured to fixedly connect the panels of the plurality of panels. The the joint system is devoid of additional joining parts to fixedly connect the plurality of panels, and the plurality of panels with the at least two columns.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a diagram of a fire wall panel system according to embodiments of the present invention;

FIG. 2 depicts a diagram of a method for installing the fire wall panel system according to embodiments of the present invention;

FIG. 3 depicts a diagram of a joint system according to embodiments of the present invention; and

FIG. 4 depicts a diagram of a second joint system according to embodiments of the present invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

Currently, the United States Code of fire safety requires a fire wall separating parts of a building must meet the following conditions:
Structural stability requires that each side of a fire wall be structurally independent of the other side IBC § 706.2;
Construction made of non-combustible materials IBC § 706.3; and
Fire resistance rating, for rooms of groups H-3 and H-4 it is required that fire walls have a fire resistance rating of 3 hours IBC § 706.4 and Table 706.4.

To comply with these stringent requirements, embodiments of a fire wall panel system with reinforced concrete columns, which is able provide fire resistance for a period of time, for example, for at least 180 minutes, are provided. The fire wall system can include the reinforced concrete panels with tongue-and-groove joint for providing a secure interlocking structure. Additionally, the system can provide Reinforced concrete columns with longitudinal grooves for the panel installation. Finally, a fire-resistant sealing compound can be applied at all seams of the wall panel system. This configuration can ensure a self-supporting, structurally independent fire wall that remains intact even if adjacent building structures collapse. Finally, the system according to embodiment of the present invention offers a fire resistance rating of at least 3 hours.

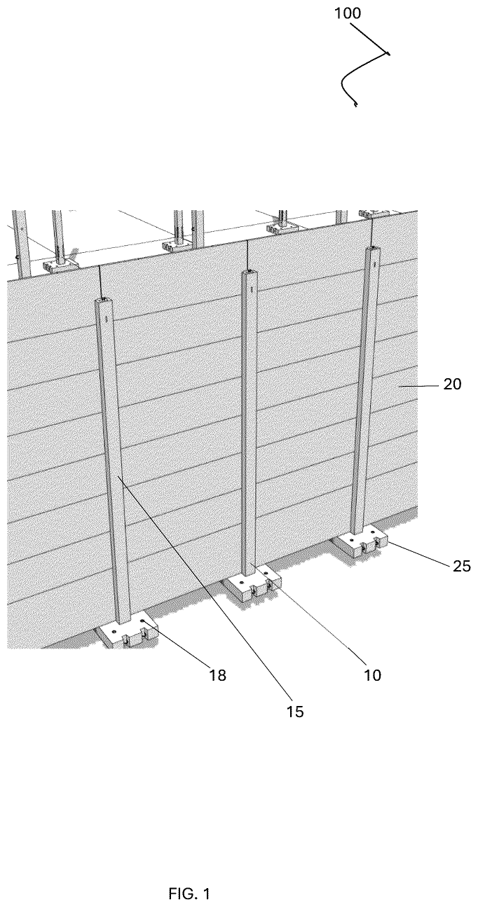

The system according to embodiments of the present invention is self-supporting and self-sustaining without the use of additional components, which are often flammable. This configuration in term allows the wall panel system to remain in place even in conditions when the outside structure walls collapse due to the heat from the fire. Embodiments of the present invention are illustrated by FIGS. 1-4 in more detail below.

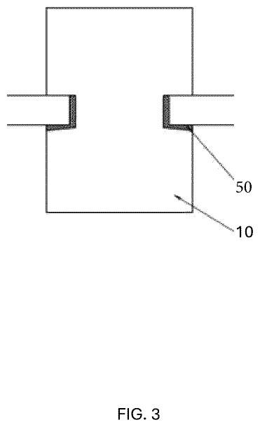

FIG. 1 shows a diagram of a fire wall panel system 100. The fire wall system 100 has a plurality of panels 20 with tongue-and-groove joint system 40 (also shown in FIG. 3) for providing a secure interlocking structure, as shown in FIG. 1.

The panels 20 can be reinforced concrete panels manufactured from a high-strength concrete, for example, having compression strength of 8000 pounds per square inch (PSI).

According to embodiment of the present invention, the length of the panels 20 can be from 25 feet to 31 feet depending on the industrial building size. The height of the panels 20 can be from 5 feet to 8 feet depending on the industrial building size. And, the thickness of the panel 20 can be about 6.5 inches in accordance with embodiments of the present invention.

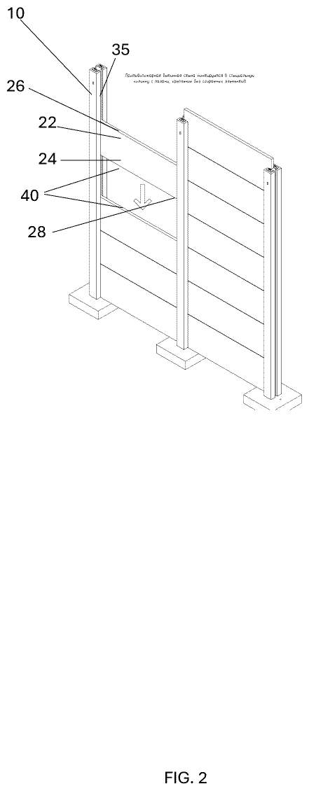

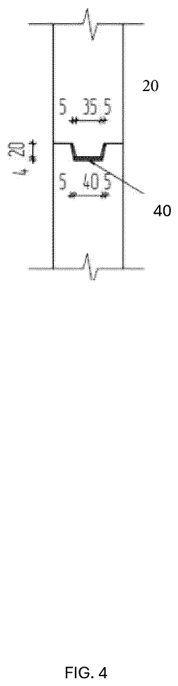

As shown in FIGS. 2 and 4, the panels 20 are provided with tongue-and-groove joint system 40 to engage the plurality of panels 20 along the x-axis. In order to facilitate the fastening of the panels 20, each panel has a first portion 22 and a second portion 24. The first portion 22 of the panel 20 is provided with a first member 26 of the tongue-and-groove joint system 40. The second portion 24 of the panel 20 is provided with a second member 28 of the tongue-and-groove joint system 40. The engagement takes place by interlock by any known means in the art so as to resist separation in a vertical direction. The engagement preferably takes place in horizontal direction downward as shown in FIG. 2. In particular, the first member 26 of one panel is configured to engage the second member 28 of the panel 20 below.

Further, as shown in FIGS. 1 and 2, the fire wall panel system 100 is provided with at least two columns 10. The panels 20 are supported by the columns 10 on each side of the panels 20. The column 10 has a vertical column part 15 fully integrated with a footer 25 (shown in FIG. 1).

The footer 25 can be provided with air outlets 18 (shown on FIG. 1). The air outlets 18 are provided to supply concrete in liquid form to level the column 10 during installation process and eliminate any voids under the column 10 after installation.

Both the column part 15 and the footer 25 can be made from high strength concrete, preferably, about 8000 pound per square inch (psi).

The column 10 is provided with a groove 35 that is part of a second tongue-and-groove joint system 50 (shown in FIG. 3) that is configured to fixedly integrate the panels 20 and columns 10. The second joint system 50 can include a tongue member 37 to be configured fixedly engaged within the groove 35. The tongue member 37 can be positioned on the side of the panel 20 that is perpendicular to the first member 26 and the second members 28 of the joint system 40.

In other words, the second joint system 50 secures the panels 20 to the columns 10, while the joint system 40 secures the panels 20 to each other in the vertical direction.

According to embodiments of the present invention, the joint systems 40, 50 allow the integrally joint panels 20 and the panels 20 being joint to the columns 10. That is, the joint systems 40, 50 do not require the insertion or attachment of additional separately made parts such as plastic or metal clips in order to join the panels. In case of a fire, this configuration prevents the additional joining parts from being compromised by the heat from the fire and cause a collapse or diminish of the structural integrity of the plurality of panels.

According to embodiment of the present invention, the panels 20 are installed by placing them in the grooves 35 of concrete columns 10 and engaging the joint systems 40, 50. When installing the panels 20, preferably, from top to bottom, thermally expanding self-adhesive fireproof tape (not shown) can be placed between the panels 20 covering the first member 26 and the second member 28. Similarly, the thermally expanding self-adhesive fireproof tape can be installed covering the groove 35 and the tongue member 37 to even further increase the fire resistance of the system 100.

Alternatively, the first member 26 and the second member 28, and the groove 35 and the tongue member 37, can be insulated by using a putty, which includes a fire-retardant material, such as an intumescent additive.

According to embodiment of the present invention, the fire wall panel system 100 provides the fire resistance for a period of time, for example, for at least 180 minutes.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A fire wall panel system, the system comprising:
a plurality of panels, each panel of the plurality of panels is fixedly connected to another panel of the plurality of panels, and each panel includes a first portion and a second portion;
a joint system configured to fixedly connect the panels of the plurality of panels; and
at least two columns configured to fixedly connect on each side of the plurality of panels,
wherein the joint system comprises a fire retardant, and
wherein the joint system is devoid of additional joining parts to fixedly connect the plurality of panels, and the plurality of panels with the at least two columns.

2. The system according to claim 1, wherein each panel of the plurality of panels comprises a concrete mixture having strength of about 8000 psi.

3. The system according to claim 1, wherein each column of the at least two columns comprise:
a vertical column part; and
a footer, the footer is configured to be integrated with the column part.

4. The system according to claim 3, wherein the footer comprises outlets that are configured to accept a material to level the column during installation process.

5. The system according to claim 1, wherein the joint system comprises a first member provided in the first portion of each of the panels of the plurality of panels and a second member provided in the first portion of each of the panels of the plurality of panels, and wherein the first member and the second member interlock so as to resist separation in a vertical direction.

6. The system according to claim 1, further comprising a second joint system, wherein the second joint system comprises:
a groove integrated in each column of the at least two columns; and
a tongue member integrated into each panel of the plurality of panels,
wherein the second joint system is configured to fixedly connect the plurality of panels with the at least two columns.

7. A method for installing a fire wall panel system, the method comprising:
providing at least two columns, each column comprising a groove;
placing a plurality of panels from top to bottom between the at least two columns;
providing a joint system configured to fixedly connect the panels of the plurality of panels, wherein the joint system comprises a first member and a second member;
covering the first member and the second member with a fire retardant; and
engaging the joint system configured to fixedly connect the panels of the plurality of panels,
wherein the joint system is devoid of additional joining parts to fixedly connect the plurality of panels, and the plurality of panels with the at least two columns.

8. The method according to claim 7, wherein each panel of the plurality of panels comprise a concrete mixture having strength of about 8000 psi.

9. The method according to claim 7, wherein each column of the at least two columns comprise:
a vertical column part; and
a footer, the footer is configured to be integrated with the column part.

10. The system according to claim 9, wherein the footer comprises outlets that are configured to accept a material to level the column during installation process.
